(19) United States
(12) Patent Application Publication
(10) Pub. No.: US 2024/0012875 A1
(43) Pub. Date: Jan. 11, 2024

(54) METHOD, SYSTEM AND COMPUTER READABLE MEDIUM FOR PROBABILISTIC SPATIOTEMPORAL FORECASTING

(71) Applicants: Soumyasundar PAL, Montreal (CA); Yingxue ZHANG, Markham (CA); Mark COATES, Montreal (CA)

(72) Inventors: Soumyasundar PAL, Montreal (CA); Yingxue ZHANG, Markham (CA); Mark COATES, Montreal (CA)

(21) Appl. No.: 18/365,568

(22) Filed: Aug. 4, 2023

Related U.S. Application Data
(63) Continuation of application No. PCT/CA22/50166, filed on Feb. 4, 2022.
(60) Provisional application No. 63/145,961, filed on Feb. 4, 2021.

(51) Int. Cl. G06F 17/17; G08G 1/08

(52) U.S. Cl. CPC G06F 17/17; G08G 1/08

(57) ABSTRACT

Probabilistic spatiotemporal forecasting comprising acquiring a time series of observed states from a real-world system, each observed state corresponding to a respective time-step in the time series and including a set of data observations of the real-world system for the respective time-step. For each of a plurality of the time steps in the time series of observed states, a hidden state is generated for the time-step based on an observed state for a prior time-step and an approximated posterior distribution generated for a hidden state for the prior time-step. The use of an approximated posterior distribution can enable improved forecasting in complex, high dimensional settings.

### RELATED APPLICATIONS

The present application is a continuation of International Patent Application No. PCT/CA2022/050166, filed Feb. 4, 2022, entitled METHOD, SYSTEM AND COMPUTER READABLE MEDIUM FOR PROBABILISTIC SPATIOTEMPORAL FORECASTING, which claims priority to and the benefit of U.S. Provisional Patent Application Ser. No. 63/145,961 filed Feb. 4, 2021, entitled METHOD AND SYSTEM PROBABILISTIC SPATIOTEMPORAL FORECASTING. The content of the related application documents identified above are incorporated herein by reference as if reproduced in their entirety.

### FIELD

The present disclosure relates generally to probabilistic spatiotemporal forecasting using machine learning techniques.

### BACKGROUND

Spatiotemporal forecasting plays an important role in various real world systems, such as traffic control systems and wireless communication systems. For example, in traffic control systems, spatiotemporal forecasting may be used in intelligent traffic management applications to predict (e.g. forecast) future traffic speeds based on historical traffic speeds obtained by sensors located throughout a road network. An example of a road network 102 with speed sensors 104(1) to 104(N) (where 104(i) denotes a generic speed sensor) disposed at various locations on the roads of the road network 102 is shown in FIG. 1. The topology of the road network 102 may be represented as a graph [symbol] =( [symbol] ,ε), where [symbol] is the set of N nodes and ε denotes the set of edges. Each speed sensor 104(i) is a node in the graph, and road sections that provide travel paths between two sensor locations are edges in the graph. Each speed sensor 104(i) measures traffic speed over a period of time and saves the measured traffic speed as a time series. The structure of the graph representing the road network encodes spatial dependencies between the locations of the speed sensors for predicting future traffic speed at the speed sensor for each road.

Combining the spatial dependencies encoded in the structure of a graph with the temporal pattern information of the time series obtained at the nodes of the graph can be problematic. Recent research has resulted in multivariate prediction algorithms which effectively utilize the structure of a graph via various Graph Neural Networks (GNN) to address this problem. In existing systems that perform spatiotemporal forecasting, graph convolution is combined with recurrent neural networks, temporal convolutions, and attention mechanisms to further encode the temporal correlation between adjacent time points in the time series. Such existing systems can generate fairly accurate point forecasts, however, these existing systems have a serious drawback as these existing system cannot gauge the uncertainty in their predictions (i.e. forecasts). Uncertainty estimation of the prediction (e.g. forecast) generated by systems that perform spatiotemporal forecasting is important because the uncertainty estimation provides information in terms of how confident the system can be about the prediction (forecast).When decisions are made based on forecasts, the availability of a confidence or a prediction interval can be vital. Accordingly, there is a need for a system that can provide forecasts and accurate confidence predictions for such forecasts.

### SUMMARY

According to a first example aspect of the present disclosure is a computer implemented method for probabilistic spatiotemporal forecasting. The computer implemented method includes acquiring a time series of observed states from a real-world system, each observed state corresponding to a respective time-step in the time series and including a set of data observations of the real-world system for the respective time-step. For each of a plurality of the time steps in the time series of observed states, the method includes: generating a hidden state for the time-step based on (i) the observed state for a prior time-step and (ii) an approximated posterior distribution generated for a hidden state for the prior time-step, and generating an approximated posterior distribution for the hidden state generated for the time-step based on (i) the observed state for the time-step and (ii) the hidden state generated for the time-step. The computer implemented method further includes generating a future time series of predicted states for the real-world system, each predicted state corresponding to a respective future time-step in the future time series. Generating the future time series of predicted states, includes: (A) for a first future time step in the future time series: generating a hidden state for the first future time step based on (i) the observed state for a final time step in the time series of observed states; and (ii) the posterior distribution for the hidden state generated for the final time step in the time series of observed states, and generating a predicted state of the real-world system for the first future time step based on the hidden state generated for the first future time step; and (B) for each of a plurality of the future time steps following the first future time step in the future time series: generating a hidden state for the future time step based on (i) the predicted state of the real-world system generated for a prior future time step and (ii) the hidden state generated for a prior future time step, and generating a predicted state of the real-world system for the future time step based on the hidden state generated for the future time step.

In at least some applications, the use of an approximated posterior distribution alternated with hidden state predictions when encoding the time series of observed states can enable improved forecasting in complex, high dimensional settings, and also provide a confidence indication for final predictions.

According to some aspects of the computer implemented method, the method computer implemented includes controlling the real-world system to modify future data observations of the real-world system based on the future time series of predicted states for the real-world system.

According to one or more of the preceding aspects of the computer implemented method, the real-world system includes a road network and the set of data observations include traffic speed observations collected at a plurality of locations of the road network.

According to one or more of the preceding aspects of the computer implemented method, the computer implemented method includes controlling a signaling device in the road network based on the future time series of predicted states for the real-world system.

According to one or more of the preceding aspects of the computer implemented method, the computer implemented method includes comprising forming a Monte Carlo approximation of a posterior distribution of the future time series of predicted states.

According to one or more of the preceding aspects of the computer implemented method, for each of the plurality of the time steps in the time series of observed states, generating the approximated posterior distribution generated for the hidden state generated for the time-step comprises using a particle flow algorithm to migrate particles of the hidden state to represent the posterior distribution.

According to one or more of the preceding aspects of the computer implemented method, for each of the plurality of the time steps in the time series of observed states and for each of the plurality of the future time step, generating of the hidden states is performed using a trained recurrent neural network (RNN).

According to one or more of the preceding aspects of the computer implemented method, for each of the plurality of the future time steps, generating the predicted state of the real-world system for the future time step is performed using a trained fully connected neural network (FCNN)

According to one or more of the preceding aspects of the computer implemented method, the predicted state of the real-world system for a future time-step includes a set of predicted observations and a prediction interval for each of the predicted observations.

According to one or more of the preceding aspects of the computer implemented method, the set of data observations of the real-world system are measured using a respective set of observation sensing devices.

According to one or more of the preceding aspects of the computer implemented method, each time series of the observed states from the real-world system is represented as a respective node in a graph and relationships between the respective times series are represented as graph edges that collectively define a graph topology, wherein: for each of the plurality of the time steps in the time series of observed states, generating the hidden state for the time-step is also based on the graph topology; and for each of the plurality of the future time including the first future time step in the future time series, generating the hidden state for the future time step is also based on graph topology.

In some aspects, the present disclosure provides a system for probabilistic spatiotemporal forecasting, the system comprising a processing system configured by instructions to cause the system to perform any of the aspects of the method described above.

In some aspects, the present disclosure provides a computer-readable medium storing instructions for execution by a processing system for probabilistic spatiotemporal forecasting. The instructions when executed cause the system to perform any of the aspects of the method described above.

### BRIEF DESCRIPTION OF THE DRAWINGS

Reference will now be made, by way of example, to the accompanying drawings which show example embodiments of the present application, and in which:

FIG. 1 shows a sample of a road network with traffic monitoring sensors.

FIG. 2 shows a sample of a road network with an intelligent traffic management system that includes a forecasting model according to example embodiments.

FIG. 3 is a block diagram illustrating components and the operation of the forecasting model according to example embodiments.

FIG. 4 is a graphical illustration of a state space of the forecasting model.

FIG. 5 graphically illustrates an example of a particle flow operation of the forecasting model.

FIG. 6 is a pseudocode representation of a process performed by the forecasting model.

FIG. 7 is a pseudocode representation of the particle flow operation of the forecasting model.

FIG. 8 is a pseudocode representation of training method for the forecasting model.

FIG. 9 is an illustrative plot of samples and prediction intervals generated by the forecasting model.

FIG. 10 is a block diagram illustrating an example of a forecasting system that can be used as an alternative to the forecasting model according to example embodiments.

FIG. 11 is block diagram illustrating some components of a processing system that may be used to implement systems and methods of example embodiments.

The same reference numerals may be used in different figures to denote similar components.

### DESCRIPTION OF THE INVENTION

The present disclosure provides a method and system for probabilistic spatiotemporal forecasting with uncertainty estimation. The system and method of the present disclosure include a probabilities method that approximates the posterior distribution of spatiotemporal forecasts. The method and system of the present disclosure provide samples from an approximate posterior distribution of a forecast.

Probabilistic spatiotemporal forecasting can be applied in many practical real world time-series prediction applications, including for example real-word dynamic systems that are related to intelligent traffic management, computational biology, finance, wireless networks and demand forecasting. The probabilistic spatiotemporal forecasting methods and systems described in this disclosure can be applied to different types of real-word dynamic systems. Examples will be illustrated in the context of intelligent traffic management, however the present disclosure is not limited to such systems.

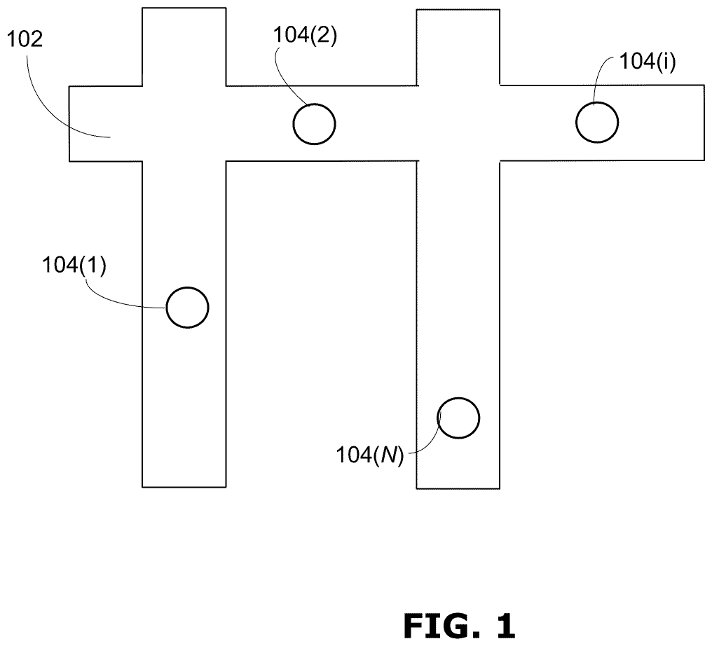

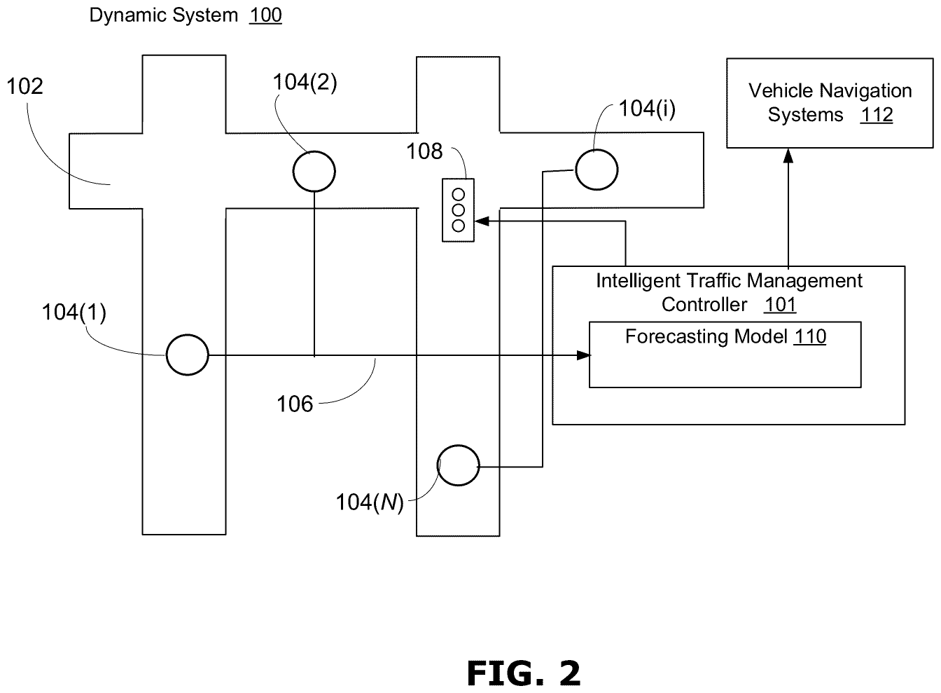

FIG. 2 shows an illustrative example of a real-world dynamic system 100 in the context of the road network 102 of FIG. 1. The dynamic system 100 includes a set of state observation devices for collecting observations (also referred to as data points or samples) (e.g., speed sensors 104(1) to 104(N) are observation devices for collecting observed traffic speed measurements (observations) at respective data sampling locations within the road network 201), an intelligent traffic management controller 101, one or more dynamic system control devices that can control future states of the dynamic system 100 (e.g., fixed traffic signaling devices such as stop lights 108); and one or more distributed ancillary control systems that can control individual, or groups of, observed elements in the dynamic system 100 (e.g., one or more vehicle navigations systems 112). These components can be inter-connected by one or more communication networks 106.

Intelligent traffic management controller 101 includes a machine learning (ML) based forecasting model 110. Forecasting model 110 obtains real-world state-space time-series observations about the dynamic system 100, including for example traffic speed measurements from the set of speed sensors 104(1) to 105(N) included at known locations within the road network 102. The time-series observations from each speed sensor 104(i) can, for example, be received by intelligent traffic management system 100 over communication network 106. Forecasting model 110 forecasts (i.e. predicts) predicts a future time-series of state-spaces based on the observed time-series data. These predictions can be processed by intelligent traffic management controller 101 to make a traffic management decision. For example, intelligent traffic management controller 101 may make traffic flow controlling and routing decisions that are effected by controlling signaling devices such as traffic flow control lights 108 (e.g., stop lights). In some examples, the predictions can be provided to one or more centralized or distributed vehicle navigation systems 112 and processed to enable real-time routing decisions (or suggestions) for individual vehicles and/or groups of vehicles. Reference will be made throughout the following disclosure to road traffic forecasting in the context of FIG. 2.

As explained below, forecasting model 110 can include neural networks that are collectively configured and trained to perform a task of discrete-time multivariate time-series prediction, with the goal of forecasting multiple time-steps ahead. A multivariate time-series consists of more than one time-dependent variable and each variable depends not only on its past values but also has some dependency on other variables. In the road traffic forecasting example of FIG. 2, each time-dependent variable corresponds to a traffic speed observation as measured by a speed sensor 104(i) at a time step t. Due to the interconnectivity of road network 102, each traffic speed observation by a speed sensor 104(i) is dependent on the observations made in time-steps prior to time step t as well as the traffic speed observations by the other speed sensors 104(1) to 104(N).

In the following description, yₜε [symbol] denotes a multivariate observed state at time step t, and [symbol] ₜ_{₀}_{:t}_{_{end}} denotes a time-series of multivariate observed states y t for a set of time steps from time step t=t₀ to time step t=t_{end}. The multivariate observed state yₜ can be an N element vector of multivariate variables, with each element corresponding to a respective observation; for example, the i-th element of multivariate observed state yₜ is the observation associated with time-series i at time-step t. In road traffic forecasting example of FIG. 2, the i-th element of multivariate observed state yₜ is the traffic speed observed and measured by a speed sensor 104(i) at a time step t. The multivariate observed state yₜ includes N respective multivariate variables, one for each of the observed traffic speeds by the speed sensors 104(1) to 104(N) at time step t. The term zₜ ∈ [symbol] denotes a covariate observed state at time step t. The covariate observed state zₜ can be a tensor (for example an N×d_{z} matrix) of covariate observations that are associated with corresponding observations represented in the multivariate observed state yₜ· [symbol] ₜ_{₀}_{:t}_{_{end}} denotes a time-series of covariate states zₜ for a set of time steps from time step t=t₀ to time step t=t_{end}. Covariate observed state zₜ may be omitted in some example applications. When available, the covariate observed state zₜ ∈ [symbol] can provide additional information about properties associated with corresponding observations include in the multivariate observed state yₜ ∈ [symbol] . For example, in a traffic forecasting scenario, the i-th element of multivariate observed state yₜ (i.e., the traffic speed observation associated with time-series i at time-step t, as measured by a speed sensor 104(i)), covariate observed state zₜ could indicate one or more properties (i.e., d_{z} properties) of the speed sensor 104(i) environment, at least some of which may be time dependent and measured by one or more sensors co-located with the speed sensor 104(i) (e.g., traffic volume, light levels, orientation, geographic location, wind speed and direction, temperature, presence and/or rate of precipitation, among other properties, measured by respective sensors in conjunction with the speed sensor 104(i)), or acquired from other sources (e.g., seasonal traffic information (yearly, weekly, and daily seasonality patterns).

In the road traffic forecasting example of FIG. 2, forecasting model 110 also has access to a graph [symbol] =( [symbol] ,ε), where [symbol] is the set of N nodes and E denotes the set of edges. Each speed sensor 104(i) corresponds to a respective node in the graph, and road sections that provide travel paths between speed sensor locations correspond to edges in the graph. Thus, each node corresponds to a respective time-series of observations. The edges indicate probable predictive relationships between the variables of the observed states, i.e., the presence of an edge (i; j) between the i-th and j-th elements represented in multivariate observed state yₜ suggests that the historical data for time-series i is likely to be useful in predicting time-series j. The graph may be directed or undirected. In some applications, graph [symbol] =( [symbol] ,ε) may not be available. In the in a traffic forecasting scenario of FIG. 2, edges can correspond to road sections that provide a navigable path from i-th speed sensor 104(i) to j-th speed sensor 104(j).

For graph [symbol] =( [symbol] ,ε), node data corresponding to the set of N nodes [symbol] for each time step t corresponds to the multivariate observed state yₜ ∈ [symbol] and the covariate observed state zₜ ∈ [symbol] . The set of edges E for the graph, which defines the graph topology, can be represented in an N by N adjacency matrix, A (hereinafter “graph topology A”).

A robust historical dataset ( [symbol] ) can be used for training forecasting model 110, but after training the forecasting model 110 performs its prediction tasks based on a limited window of historical data. As will be explained below, forecasting model 110, is configured to process, for some time offset t₀, a multivariate observed state time-series [symbol] ₜ_{₀}_{+1: t}_{₀}₊ₚ, an covariant observed state time-series [symbol] ₜ_{₀}₊₁ₜ_{₀}_{+p+Q}, and graph topology A (if available) to estimate (i.e., forecast) a predicted state time-series [symbol] ₜ_{₀}_{+p+1:t}_{₀}_{+p+Q}, where P is the number of time-steps in the observed state time-series data and Q is the number of time steps in the predicted state time-series data. By way of illustrative example, in the case of a traffic forecasting example, each time-step could be 5 minutes, and P could correspond to an interval of 15, 30, 45 or 60 minutes. The time offset t₀ will be omitted for the remaining description to provide brevity.

In example embodiments, the forecasting model 110 generates prediction results that include a posterior distribution of the time series forecasting, gathered from particle predictions for Np particles for each time-step. The mean of the particle predictions can be used as the final prediction result (e.g., as a point estimate) and the distribution of the particle predictions as an uncertainty characterization for the prediction results and a confidence indicator in the form of a prediction interval. Each predicted state of the real-world system includes, for each respective time-series, a posterior distribution of particles, wherein a mean of the posterior distribution is used as a predicted observation for the time-series for the future time step and the posterior distribution of particles is used to generate a confidence indicator. Thus, in examples, forecasting model 110 outputs: (i) point estimates (also referred to as predicted or forecast samples) (e.g., a predicted traffic speed) for each time step for each time-series i (e.g., for each speed sensor 104(i)), and (ii)_corresponding prediction intervals. A prediction interval is an indication of confidence in a prediction and indicates a range that future individual point observations will fall within relative to the predicted point estimate. For example, in a traffic speed forecasting scenario, a 95% prediction interval will include an upper speed value and a lower speed value with respect to a predicted speed sample for speed sensor 104(i) for a future time step, and is an indication, with a 95% probability that the actual observed speed value for the speed sensor 104(i) for that future time step will fall within the range of the upper speed value and the lower speed value. The narrower the prediction interval range, the greater the prediction confidence.

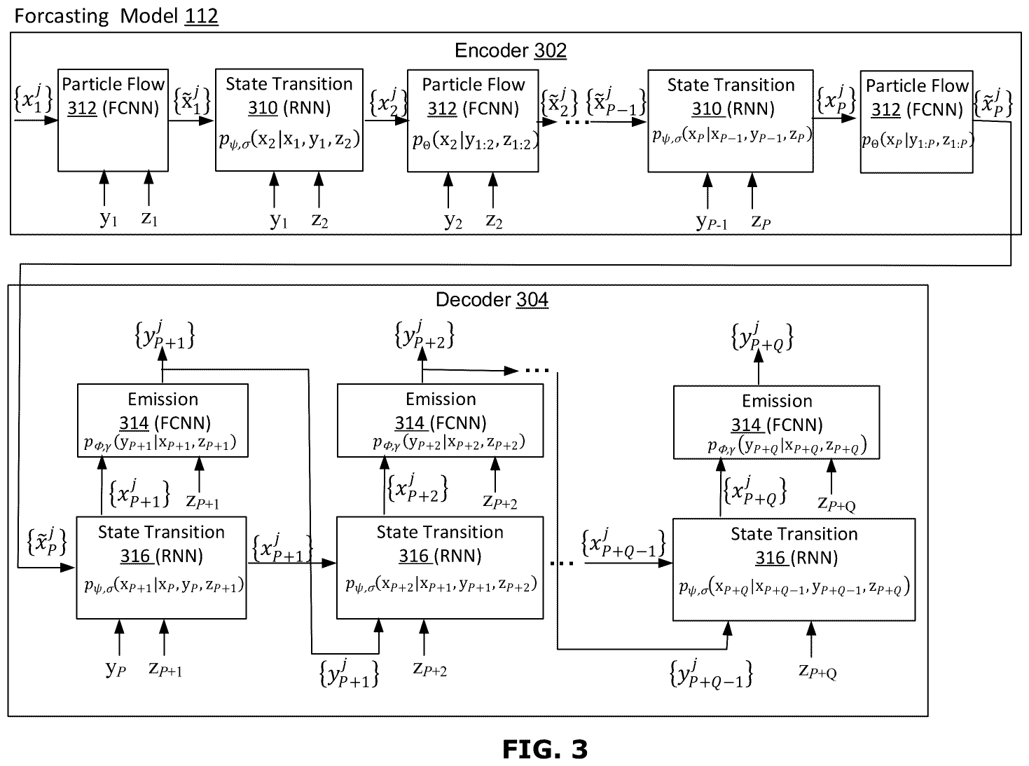

An example of forecasting model 110, according to an example aspect of the disclosure, is illustrated in the block diagram of FIG. 3. In the illustrated example, forecasting model 110 includes an encoder 302 that generates a time series of hidden states xₜ for an input time series of multivariate observed states yₜ and a decoder 304 that outputs a time series of predicted future states Y_{tfuture} As indicated in FIG. 3, encoder 302 performs a set of alternating particle flow operations 312 and state transition operations 310. Decoder 304 performs pairs of state transition operations 316 and emission operations 314. In example embodiments, recurrent neural networks (RNN) based models are trained to perform state transition operations 310, 316. A fully connected neural network (FCNN) model is trained to perform emission operations 314.

In example aspects of the disclosure, forecasting model 110 operates based on the postulation that observed multivariate observed state yₜ ∈ [symbol] is an observation from a Markovian state space model with a hidden (i.e., unobserved) state Xₜ ∈ [symbol] . The state space for forecasting model 110 can be represented as:

xᵢ=˜p [symbol] ( [symbol] Z: [symbol] p)

xᵢ=g [symbol] ,o(Xₜ₋₃,yₜ₋₁,zₜ,vₜ),fort>1,

yᵢ=h [symbol] [symbol] (xₜ,zₜ,wₜ),fort≥1 (EQ. 1)

Where xᵢ is an initial hidden state, Vₜ˜pᵥ(·|Xₜ₋₁,σ) is a process noise latent state; wₜ˜P_{w}(·|xₜ,γ) is a measurement noise latent state; p, σ and y are parameters of distribution of the initial hidden state Xᵢ, process noise latent state vₜ and measurement noise latent state wₜ, respectively; and g and h denote system dynamics (transition) and measurement (observation) approximating functions with parameters ψ and Φ respectively. The subscript [symbol] in functions g and h indicates that the functions are potentially dependent on the graph topology A of graph [symbol] . The measurement function h_{g,o}(xₜ,zᵢ,o) is a differentiable function whose first derivative w.r.t. hidden state xₜ is continuous.

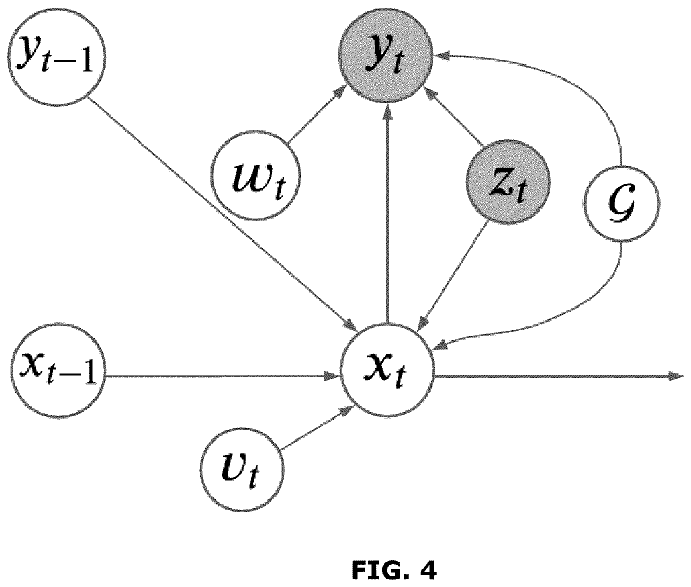

Accordingly, the complete set of learnable parameters for forecasting model 110 is formed as ⊖={p, ϕ, σ, ϕ, γ}. FIG. 4 depicts a graphical representation of the state space of forecasting model 110 for time step t, illustrating the relations of hidden state xₜ, observed variables (multivariate observed state yₜ, covariate observed state zₜ), latent variables (process noise latent state yₜ, measurement noise latent state wₜ) and the graph [symbol] .

In example aspects, the ML model 112 is configured to approximate the following prediction function:

$$\\ \begin{matrix}{p}_{Θ} ( {y}_{P + 1 : P + Q} \vert {y}_{1 : P} , {z}_{1 : P + Q} ) = \int {\prod }_{t = P + 1}^{P + Q} ( {p}_{ϕ , γ} ( {y}_{t} \vert {x}_{t} , {z}_{t} ) {p}_{ψ , σ} ( {x}_{t} \vert {x}_{t - 1} , {y}_{t - 1} , {z}_{t} ) ) {p}_{Θ} ( {x}_{P} \vert {y}_{1 : P} , {z}_{1 : P} ) {dx}_{P : P + Q} . & EQ . ( 2 )\end{matrix}$$

In particular, as explained below, the term p_{ψ,σ}(Xₜ|Xₜ₋₁, yₜ₋₁, zₜ) is approximated by state transition operations 310, 316; the term P⊖(XP|Y1:P, Z1:P) is approximated by particle flow operation 312; and the term p_{ϕγ}(yₜ|xₜ, zₜ) is approximated by emission operation 314.

The integral in Equation (2) is analytically intractable for a general non-linear state-space model. Accordingly, ML model 112 applies a Monte Carlo approximation of the integral, as will be explained below.

Each the operations 310, 312, 314, 316 and their respective approximations of the above equations terms will now be described according to example aspects of the disclosure.

RNN model based state transition operations 310, 316, can, in example embodiments, be performed using an Adaptive Graph Convolution Gated Recurrent Unit (AGCGRU) as presented in the published paper “Bai, L., Yao, L., Li, C., Wang, X., and Wang, C. Adaptive graph convolutional recurrent network for traffic forecasting. In Proc. Neural Info. Process. Systems (NeurIPS), 2020” (Reference 1). In such cases, an AGCGRU is used to approximate the function pψ,σ(xₜ|xₜ₋₁, yₜ₋₁,zₜ).

As described in Reference 1, an AGCGRU combines (i) a module that adapts a provided graph based on observed data, (ii) graph convolution to capture spatial relations, and (iii) a gated recurrent unit (GRU) to capture evolution in time. An example RNN model used for state transition operations 310, 316 employs an L-layer AGCRU with additive Gaussian noise to model the system dynamics function g:

$$\\ \begin{matrix}{x}_{i} = {AGCGRU}_{ℊ , ψ}^{( L )} ( {x}_{i - 1} , {y}_{t - 1} , {z}_{t} ) + {v}_{t} & EQ . ( 3 )\end{matrix}$$

In Equation (3), Pᵥ(vₜ)= [symbol] (0, σ²I). i.e., the latent variables for the system dynamics function g are independent. The initial state distribution is chosen to be isotropic Gaussian, i.e. p [symbol] (xₜ,zₜ,p)= [symbol] (0,p²I). The parameters p and a are learnable variance parameters.

As indicated in FIG. 3, each state transition operation 310 of encoder 302 receives as inputs, for its respective time-step t (where t={1, 2, . . . , P}): (i) a multivariate observed state yₜ₊₁ for time step t−1; (ii) a covariate observed state Z t for the subject time step t+1; (iii) graph topology A of graph [symbol] ; and (iv) an approximated posterior distribution p_{Θ}(xₜ₋₁|Y_{1:t-1}, z_{1:t-1}) of hidden state xₜ₋₁, as generated by a preceding particle flow operation 312 (discussed in greater detail below). Based on its respective inputs for its respective time step t, each state transition operation 310 computes a time-step hidden state xₜ. As indicated above, in some example embodiments one or both of the inputs for covariate observed state z, and graph topology A may be omitted.

In the case of decoder 304, the state transition operation 316 for time step t=P+1 receives as inputs:(i) the multivariate observed state yₚ for time step P; (ii) a covariate state zₚ₊₁ for the time step P+1; (iii) graph topology A of graph [symbol] ; and (iv) the approximated posterior distribution \tilde{X}ₚ of hidden state XP. Based on its respective inputs, the state transition operation 310 for time step t=P+1 computes a predicted future time-step hidden state XP+2.

In the case of the decoder state transition operations 316 for each of the time steps t={P+2, . . . ,P+Q}, the respective inputs to the state transition operation 316 for the time step are: (i) the predicted state yₜ₋₁ for time step t−1 as generated by an emission operation 314 for the previous time step (explained below); (ii) a covariate state zₜ for the subject time step t (features for future time steps can be provided at inference time); (iii) graph topology A of graph [symbol] ; and (iv) the predicted hidden state xt−1 generated by the previous state transition operation 316. Based on their respective inputs, each respective state transition operation 310 for each of the time steps t={P+1, . . . ,P+Q} computes a respective predicted future time-step hidden state xₜ.

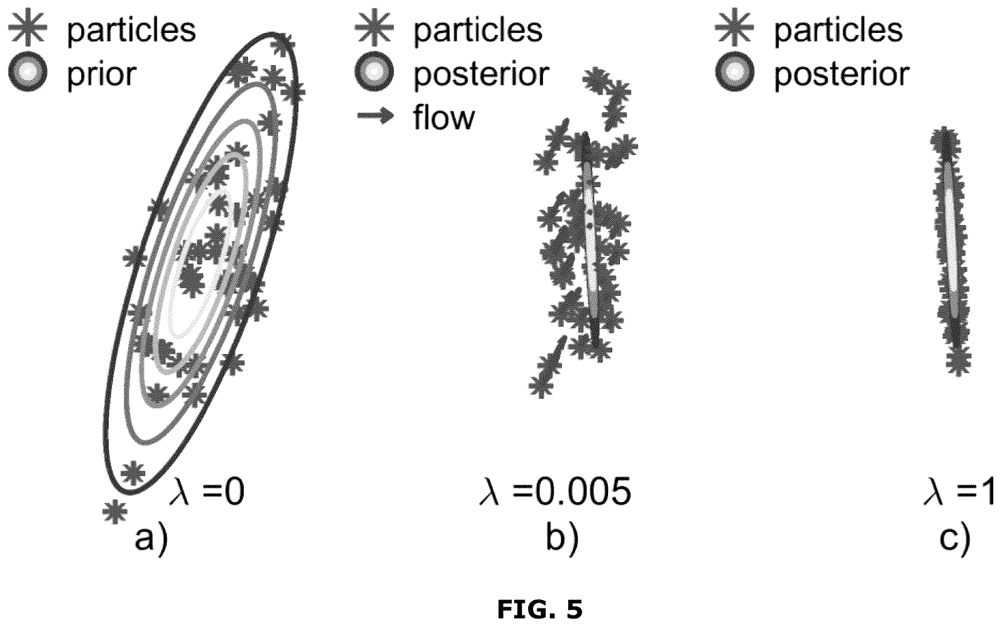

Particle flow operations 312 will now be described in greater detail. Each hidden state xₜ defines a distribution of Np continuous variable elements, referred to as particles. As noted above, in encoder 302, an approximated posterior distribution \tilde{x}ₜ=P_{Θ}(xₜ|Y_{1;p},z_{1:t}) of hidden state xₜ, is generated by a respective particle flow operation 312 for each time step t. For example, particle flow operation 312 can apply a particle flow algorithm that, for a given time step t, solves differential equations to gradually migrate particles from the predictive distribution (e.g., hidden state xₜ) so that they represent the posterior distribution for that hidden state after the flow. A particle flow can be modelled by a background stochastic process η, in a pseudo-time interval λ∈[0,1], such that the distribution of η₀ is the prior predictive distribution p_{Θ}(xₜ|y_{1:t-1}) and the distribution of η₁ is the posterior distribution p_{Θ}(xₜ|y_{1:t}). A graphical representation of a particle flow operation is illustrated in FIG. 5, where the * symbol is used to illustrate particles, a set of shaded ovals are used to illustrate distributions of the particles, and arrows are used to indicate a flow of respective particles as they transition between time steps. Item a) of FIG. 5 shows a prior predictive distribution P_{Θ}(xₜ|Y_{1:t-1}), item b) shows particles with flow predictions at an intermediate time, and item c) shows an example of an approximated posterior distribution p_{Θ}(xₜ|y_{1:t}). Examples particle flow algorithms that can be used for particle flow operation 312 is described in the published papers: “Daum, Fred, and Jim Huang. “Particle flow for nonlinear filters.” 2011 IEEE International Conference on Acoustics, Speech and Signal Processing (ICASSP). IEEE, 2011.” (Reference 2); and “Li, Yunpeng, and Mark Coates.” Particle filtering with invertible particle flow. “IEEE Transactions on Signal Processing 65.15 (2017): 4102-4116” (Reference 3). Accordingly, in an example embodiment, particle flow operations 312 apply a particle flow algorithm with Np particles to recursively approximate posterior distributions for each of the hidden states xₜ (where t={1,2, . . . P−1}), represented as follows:

$$\\ \begin{matrix}{p}_{Θ} ( {x}_{t} \vert {y}_{1 : t} ; {z}_{1 : t} ) \approx \frac{1}{{N}_{p}} {\sum }_{j = 1}^{{N}_{p}} δ ( {x}_{t} - {x}_{t}^{i} ) . & EQ . ( 4 )\end{matrix}$$

Where {Xₜⁱ}ⱼ₌₁^{N}^{ₚ} are approximately distributed according to the posterior distribution of hidden state xₜ. In FIG. 3, the approximated posterior distribution is illustrated denoted as: {\tilde{X}ₜ}.

As indicated in FIG. 3, each particle flow operation 312 of encoder 302 receives as inputs, for its respective time-step t (where t={1, 2, . . . , P−1}): (i) a multivariate observed state yₜ; (ii) a covariate observed state zₜ; and (iii) a hidden state xₜ. Based on its respective inputs for its respective time step t, each particle flow operation 312 computes an approximated posterior distribution {\tilde{x}ₜ}={xₜ^{j}}ⱼ₌₁^{N}^{ₚ}=P_{Θ}(xₜ|Y_{1:t}, z_{1:t}) of hidden state xₜ. In alternative examples, particle filtering can be used in place of particle flow for approximating a posterior distribution.

Emission operations 314 will now be described in greater detail. The FCNN based model that performs emission operation 314 can be represented as:

yₜ=W_{ϕx}_{ₜ}+Wₜ EQ. (5)

Where w_{ϕ} is a linear projection matrix and latent variable wₜ for the emission operation is modelled as Gaussian with variance dependent on hidden state xₜ via a learnable softplus function:

P_{w}(wₜ|xₜ)= [symbol] (0,diag(softplus( [symbol] _{γ}x;ₜ))². EQ. (6)

As indicated in FIG. 3, each emission operation 314 of decoder 304 receives as inputs, for its respective time-step t (where t={P,P+1, . . . ,P+Q}): (i) a hidden state xₜ; and (ii) a covariate state Z t. Based on its respective inputs for its respective time step t, each emission operation 314 computes a future predicted state yₜ for the dynamic system that is being observed. The future predicted state yₜ can include a predicted point sample for each of N observation points in the dynamic system, as well as a predicted distribution that corresponds to a prediction interval (the predicted point samples and distribution can be denoted as {yₜ^{j}}, where 1≤j≤Np.)

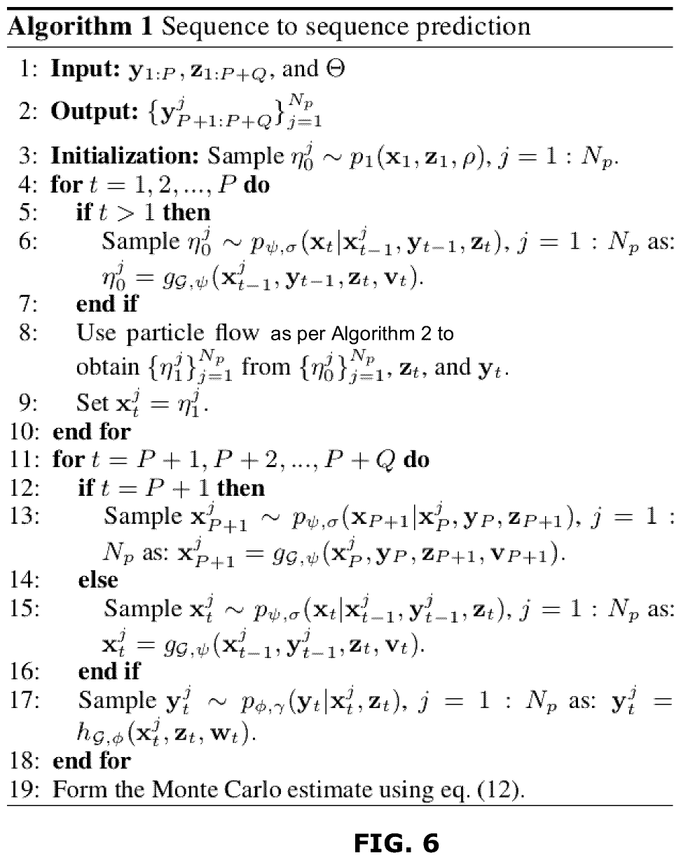

An example of a probabilistic spatiotemporal forecasting task in which a sequence of recent historic data is used to predict a sequence of future data for a real-word dynamic system (e.g., the dynamic system 100), performed by forecasting model 110, is illustrated in the pseudocode “Algorithm 1” of FIG. 6 and will now be explained in greater detail.

As indicated in line 1 of Algorithm 1, the inputs provided to forecasting model 110 include: a time series sequence of multivariate observed states yₜ for a set of historic time steps t={1, . . . ,P}; a time series sequence of covariate observed states Z t for a set of historic time steps t={1, . . . ,P} (optional in some examples); a graph adjacency matrix A providing a graph topology of the observed system (optional in some examples); and an initial set of forecasting model parameters ⊖={p, ψ, σ, ϕ, γ}. As indicated in line 2, the output of forecasting model 110 is a time series sequence of predicted states [symbol] y [symbol] for a set of future time steps t={P+1, . . . ,P+Q}. The results for each future predicted state [symbol] y [symbol] includes the posterior distribution of the time series forecasting, gathered from the prediction results for the Np particles. The mean of the particle predictions is used as the final prediction result and the distribution of the particle prediction results as the uncertainty characterization for the prediction results and a confidence indicator in the form of a prediction interval. As indicated line 3, initial hidden states xi and initial hidden state particle distribution ηⁱ₀ can be randomly sampled from a stochastic distribution.

In Algorithm 1, lines 4 to 10 correspond to a first processing step (Step 1) that includes operations performed by encoder 302 in respect of observed time steps t=1, 2, . . . ,P, and lines 11 to 18 correspond to a second processing step (Step 2) that includes operations performed by decoder 304 in respect of future time steps t=P+1, . . . ,P+Q.

Step 1: For each of the time steps t=1, 2, . . . ,P, particle flow operations 312 and state transition operations 310 respectively generate a approximated posterior distribution p_{Θ}(xₜ|y_{1:t}) and hidden state Xₜ using the methodologies described above. Each hidden state Xₜ incudes a distributed set of Nₚ particles, {xₜ^{j}}. The hidden state output Xₜ by the state transition operation 310 for time step t is used as the input for the particle flow operation 312 for the same time-step t. The approximated posterior distribution p_{Θ}(xₜ|y_{1:t}) from each particle flow operation 312 for a time-set t is used as the input for the state transition operation 310 for the next time-step t+1. In this manner, the posterior distributions of the hidden states are recursively approximated.

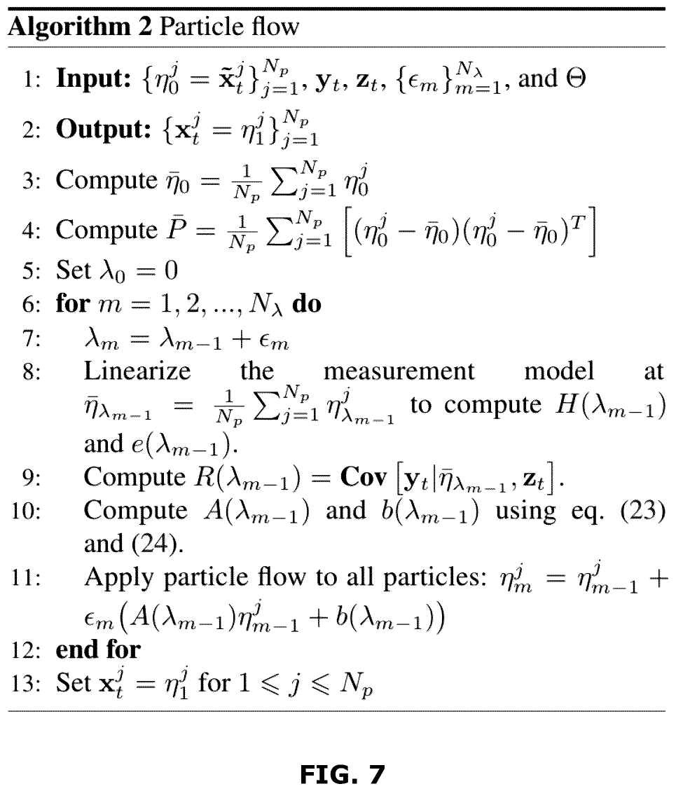

An example of a particle flow process that can be used to implement particle flow operation 312 is illustrated in the pseudocode “Algorithm 2” of FIG. 7.

Step 2: For each of the time steps t={P+1, . . . ,P+Q}, decoder 304 iterates between the following two operations:

(A) State transition operation 316, which samples hidden state particles x, t as particles (i) in the case of t={P+1}, from the hidden state approximated posterior distribution P_{Θ}(xₜ₋₁|Y_{1:t-1}Zₜ), and (ii) in the case of t={P+2, . . . ,P+Q}, from the hidden state xₜ₋₁ output by the previous time step state transition operation 316 (e.g., from p_{ψ,σ}(xₜ|xₜ₋₁, yₜ₋₁, zₜ)) to output a respective hidden state Xₜ. This amounts to a state transition at time t to obtain the current hidden state xₜ from the previous state xₜ₋₁ as per the above noted function p_{Θ}(xp|y_{1:p}, z_{1:p}); and

(B) Emission operation 314, which samples a prediction y′t (i.e., a forecasted sample) from hidden state Xₜ., using the previously described measurement function h (i.e., Yₜ=h_{g,ϕ}(xₜ, zₜ, wₜ).

As indicated at line 19 of Algorithm 1, once Steps 1 and 2 are complete, a Monte Carlo (MC) approximation of the integral in EQ. (2) is then formed as:

$$\\ \begin{matrix}{p}_{Θ} ( {y}_{P + 1 : P + Q} \vert {y}_{1 : P} , {z}_{1 : P + Q} ) \approx {\prod }_{t = P + 1}^{P + Q} \frac{1}{{N}_{p}} {\sum }_{j = 1}^{{N}_{p}} δ ( {y}_{t} - {y}_{t}^{j} ) . & EQ . ( 7 )\end{matrix}$$

Each prediction sample y^{j}_{P}+1:p+Q is approximately distributed according to the joint posterior distribution of predicted state YP+1:P+Q.

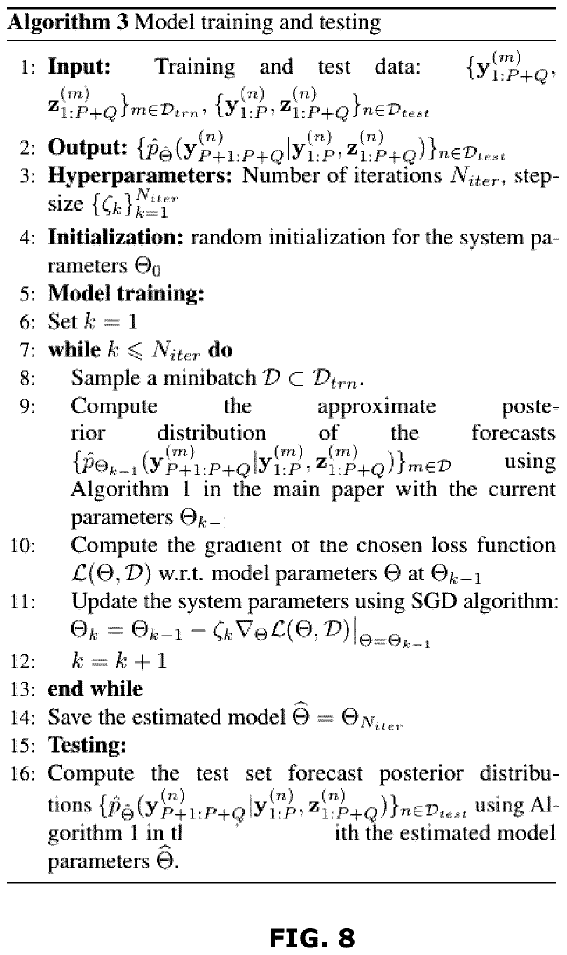

As noted above, a comprehensive historical dataset ( [symbol] ) can be used for training forecasting model 110. The forecasting model parameters Θ={p, ψ, σ,ϕ,γ}. can be initialized by random sampling, and updated during training using gradient decent. An example of a training process that can be used to train the implement particle flow operation 312 is illustrated in the pseudocode “Algorithm 3” of FIG. 8.

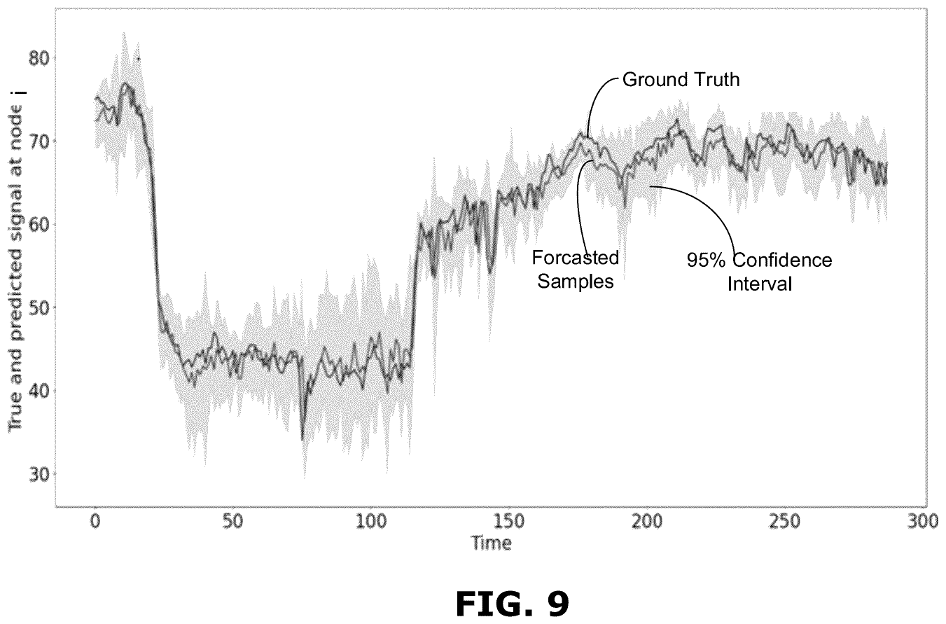

For illustrative purposes, FIG. 9 shows a plot of forecasted samples y′t for a specific time series corresponding to a single observation location (for example, speed sensor 104(i)). The forecasted samples are plotted relative to actual ground truth measurements. A prediction interval plot, shown in shading, is shown to indicate a range that that 95% of actual measured values should fall within relative to the forecasted samples y^{j}ₜ. The relatively prediction intervals can provide a decision making function (e.g., a decision module of intelligent traffic management controller) with a confidence indication that can be used to inform a control decision (e.g., controlling signaling lights 108 throughout road network 102) to impact future states.

From the above disclosure, it will be noted that forecasting model 110 considers time-series data from a dynamic system as a random realization from a nonlinear state-space model and targets Bayesian inference of the hidden states for probabilistic forecasting. Particle flow analysis is sued as a tool for approximating the posterior distribution of the states. Particle flow analysis may, in some applications, be highly effective in complex, high-dimensional settings. In at least some scenarios, forecasting model 110 may provide better characterization of uncertainty while maintaining comparable accuracy to the state-of-the art point forecasting methods.

The systems and methods of this disclosure include embodiments that model multivariate time-series as random realizations from a nonlinear state-space model, and target Bayesian inference of the hidden states for probabilistic forecasting. The disclosed systems and methods can be applied to univariate or multivariate forecasting problems, can incorporate additional covariates, can process an observed graph, and can be combined with data-adaptive graph learning procedures. In the illustrated example, the dynamics of the state-space model are built using graph convolutional recurrent architectures. An inference procedure employs particle flow, which may in some scenarios, conduct more effective inference for high-dimensional states when compared to particle filters of known forecasting solutions. In the illustrated examples, a graph-aware stochastic recurrent network architecture and inference procedure is disclosed that combines graph convolutional learning, a probabilistic state-space model, and particle flow.

Further details and example aspects of systems and methods for probabilistic spatiotemporal forecasting according to the rpesent disclosure will now be provided. Observations of an observed time series are received from a state-space model. An observation is an observed measurement in the observed time series (e.g. traffic speed) that is influenced by a latent state variable. The observation is a noisy transformation of the latent state variable of a recurrent neural network (RNN). Since the parameters of the RNNs and fully connected networks (FCNNs) of an example system (for example, forecasting model 110) of the present disclosure that performs spatiotemporal forecasting are unknown, the posterior distribution of the forecast generated by the system is maximized during training of the system to learn parameters of the RNNs and the FCNNs of the system. At each epoch during training of the system, the posterior distribution is computed based on the current value of the parameters of the RNNs and the FCNNs and a stochastic gradient based backpropagation algorithm is used to update the parameters of the RNNs and the FCNNs. Based on the trained system (e.g. the system with the parameters of the RNN and FCNNs having been learned), Bayesian inference of the states of the RNNs (“RNN states”) is performed to obtain the approximate posterior distribution of the forecasts during training. Because Bayesian inference in the high dimensional space of RNN states is performed, many conventional Bayesian inference techniques become inefficient. The method and system of the present disclosure uses particle flow for computing the posterior distribution of RNN states, as it is shown to be highly effective in complex high-dimensional settings.

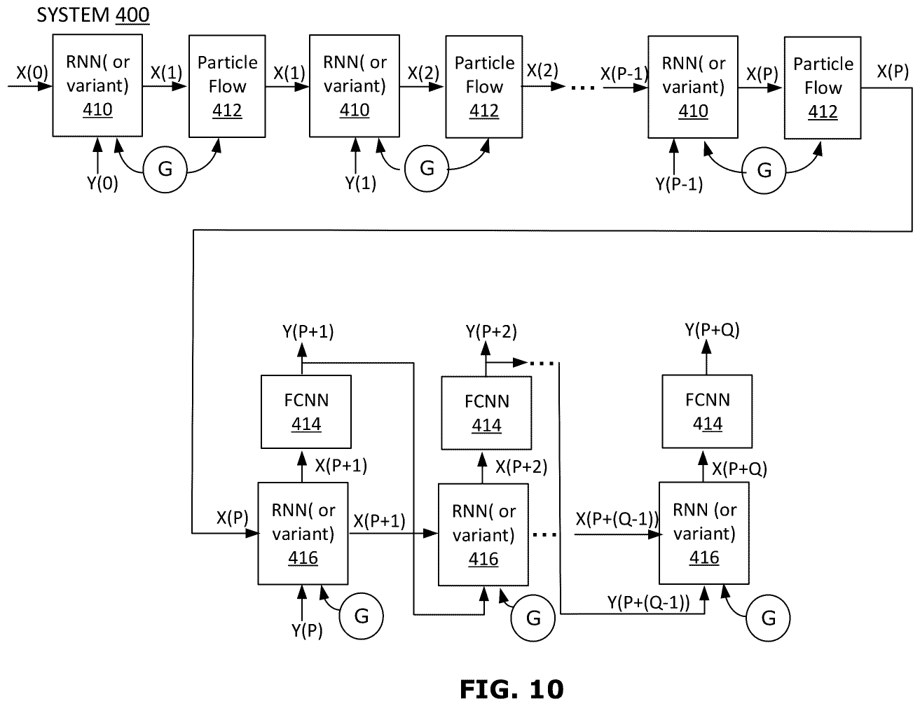

FIG. 10 shows a further example embodiment that can be used for probalistic spatiotemporal forecasting, hereinafter referred to as system 400. System 400 is similar to forecasting model 110, with the exception of difference that will be apparent from the following description. System 400 performs probabilistic spatiotemporal forecasting with uncertainty estimation in accordance with an embodiment of the present disclosure. Steps 1 to 3 described below are performed by the system 400 of FIG. 10. The system 400 of FIG. 10 receives, from a state-space model, a vector Y (t) of observations for a given time obtained at a node of the graph. For example the vector Y (t) may include observed traffic speed measurements at a particular time obtained by each sensor in a road network. The system is specified as follows:

x⁽⁰⁾˜ [symbol] (0·p² [symbol] ).

x^{(t)}=RNN(Y^{(t-1)}·X^{(t-1)}).

y^{(t)}=X^{(t)}Wₚᵣₒⱼ+V^{(t)}·v^{(t)}˜ [symbol] (0·δ² [symbol] )

The transition of the latent (i.e. hidden) state X^{(t)} is governed by a recurrent neural network (RNN) and the measurement function is a linear. The initial latent (i.e. hidden) state X⁽⁰⁾ is assumed to be distributed according to a isotropic Gaussian distribution and the measurement noise v^{(t)} is also Gaussian. The system 400 has access to a graph G, which encodes spatial relationships among different dimensions of Y^{(t)}. Any suitable RNN may be used which either exploits the structure of the graph for learning or learns a graph from the observed time series and incorporate it into learning. The system 400 performs spatiotemporal forecasting by accessing the first P steps for the observations Y^{(t)} (i.e. Y^{(1:P})) and generating predictions (e.g. forecasts) for the next Q steps (i.e. Y^{(P+1:P±Q)}). In a Bayesian setting, this amounts to the system computing the posterior distribution of the forecasts, which is expressed as follows:

$$\\ {p}_{Θ} ( {Y}^{( P + 1 : P + Q )} \vert {Y}^{( 1 : P )} ) = \int {\prod }_{t = P + 1}^{P + Q} {p}_{Θ} ( {Y}^{( t )} \vert {X}^{( t )} ) {\prod }_{t = P + 1}^{P + Q} {p}_{Θ} ( {X}^{( t )} \vert {Y}^{( t - 1 )} , {X}^{( t - 1 )} ) {p}_{Θ} ( {X}^{( P )} \vert {Y}^{( 1 : P )} ) {dX}^{( P : P + Q )} .$$

Θ denotes the parameters of the RNNs and the FCNNs of the system 400 of FIG. 20. The three different terms are explained as follows:

$$\\ {p}_{Θ} ( {X}^{( P )} \vert {Y}^{( 1 : P )} ) : probabilistic encoder , Bayesian inference$$

$$\\ {\prod }_{t = P + 1}^{P + Q} {p}_{Θ} ( {X}^{( t )} \vert {Y}^{( t - 1 )} , {X}^{( t - 1 )} ) : R N N propagation$$

$$\\ {\prod }_{t = P + 1}^{P + Q} {p}_{Θ} ( {Y}^{( t )} \vert {X}^{( t )} ) : linear projection$$

The integral above is intractable, and the system of FIG. 3 approximates the integral using Monte Carlo sampling. The approximate posterior distribution of the forecasts is obtained as follows:

Step 1: The system 400 shown in FIG. 10 uses a particle flow algorithm for the first P steps of a time series to approximate the posterior distribution of X(P). Based on the form of the prior distribution and the likelihood, particle flow algorithm solves a differential equation to migrate the samples of the prior distribution to the posterior distribution s, for example as shown in FIG. 5.

The diagram (a) on the left shows the samples (shown in asterisk) from the prior distribution (contours shown in lines). The diagram (b) in the middle shows the contours of the posterior distribution and the direction of flow for the particles, and the diagram (c) on the right shows the particles after the flow is complete.

FIG. 5 shows how the particles follow a trajectory determined by the particle flow algorithm to be distributed according to the posterior distribution.

Step 2: For t=P+1 to P+Q, the system 400 shown in FIG. 10 propagates particles (samples) from time step t−1 through the RNN 410.

Step 3: The system shown in FIG. 10 uses a linear measurement function (e.g. a fully connected neural network (FCNN) 414) on the states generated by RNN 416 to obtain the samples of the forecasts. Because a distribution of the forecasts is being learned, both the prediction values (average across prediction samples) and the uncertainty estimation (confident interval of the prediction samples) are generated by the system 400 shown in FIG. 10.

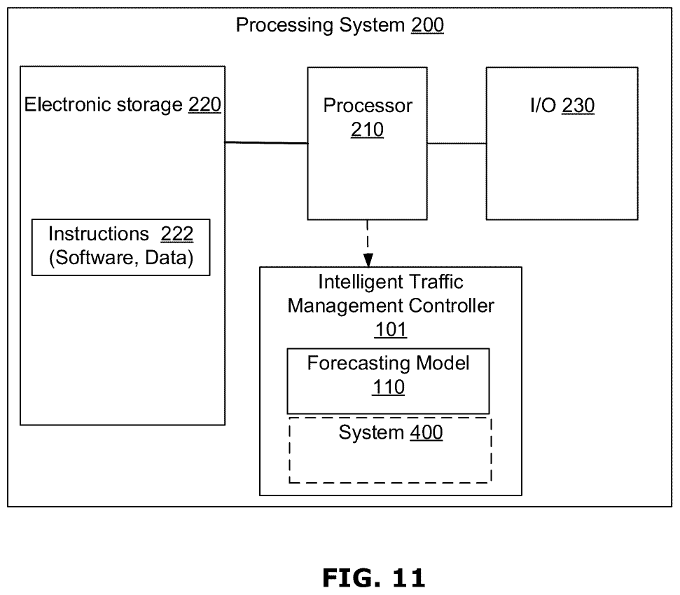

FIG. 11 illustrates an example of a processing system 200 that can be used to implement one or more components of Intelligent Traffic Management Controller 101. The processing system 200 includes one or more processors 210. The one or more processors 210 may include a central processing unit (CPU), a graphical processing unit (GPU), a tensor processing unit (TPU), a neural processing unit (NPU), a digital signal processor, and/or another computational element. The processor(s) 210 are coupled to an electronic storage(s) 220 and to one or more input and output (I/O) interfaces or devices 230 such as network interfaces, user output devices such as displays, user input devices such as touchscreens, and so on.

The electronic storage 220 may include any suitable volatile and/or non-volatile storage and retrieval device(s), including for example flash memory, random access memory (RAM), read only memory (ROM), hard disk, optical disc, subscriber identity module (SIM) card, memory stick, secure digital (SD) memory card, and other state storage devices. In the example of FIG. 11, the electronic storage 220 of the processing system 200 stores instructions 222 (executable by the processor(s) 210) for implementing various system components of Intelligent Traffic Management Controller 101, including for example forecasting model 110 and system 400.

As used herein, statements that a second item (e.g., a signal, value, scalar, vector, matrix, calculation, or bit sequence) is “based on” a first item can mean that characteristics of the second item are affected or determined at least in part by characteristics of the first item. The first item can be considered an input to an operation or calculation, or a series of operations or calculations that produces the second item as an output that is not independent from the first item. As used herein, the terms “comprising”, “comprises”, “including” and “includes” are inclusive terms and do not exclude other elements or components that are not listed.

Although the present disclosure describes methods and processes with operations in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The contents of all publications referenced in this disclosure are incorporated by reference.

1. A computer-implemented method for probabilistic spatiotemporal forecasting comprising:
acquiring a time series of observed states from a real-world system, each observed state corresponding to a respective time-step in the time series and including a set of data observations of the real-world system for the respective time-step;
for each of a plurality of the time steps in the time series of observed states:
generating a hidden state for the time-step based on (i) the observed state for a prior time-step and (ii) an approximated posterior distribution generated for a hidden state for the prior time-step, and
generating an approximated posterior distribution for the hidden state generated for the time-step based on (i) the observed state for the time-step and (ii) the hidden state generated for the time-step;
generating a future time series of predicted states for the real-world system, each predicted state corresponding to a respective future time-step in the future time series, comprising:
for a first future time step in the future time series:
generating a hidden state for the first future time step based on (i) the observed state for a final time step in the time series of observed states; and (ii) the posterior distribution for the hidden state generated for the final time step in the time series of observed states, and
generating a predicted state of the real-world system for the first future time step based on the hidden state generated for the first future time step; and
for each of a plurality of the future time steps following the first future time step in the future time series:
generating a hidden state for the future time step based on (i) the predicted state of the real-world system generated for a prior future time step and (ii) the hidden state generated for a prior future time step, and
generating a predicted state of the real-world system for the future time step based on the hidden state generated for the future time step.

2. The method of claim 1 comprising controlling the real-world system to modify future data observations of the real-world system based on the future time series of predicted states for the real-world system.

3. The method of claim 1 wherein the real-world system includes a road network and the set of data observations include traffic speed observations collected at a plurality of locations of the road network.

4. The method of claim 3 comprising controlling a signaling device in the road network based on the future time series of predicted states for the real-world system.

5. The method of claim 1 comprising forming a Monte Carlo approximation of a posterior distribution of the future time series of predicted states.

6. The method of claim 1 wherein, for each of the plurality of the time steps in the time series of observed states, generating the approximated posterior distribution generated for the hidden state generated for the time-step comprises using a particle flow algorithm to migrate particles of the hidden state to represent the posterior distribution.

7. The method of claim 1 wherein, for each of the plurality of the time steps in the time series of observed states and for each of the plurality of the future time step, generating of the hidden states is performed using a trained recurrent neural network (RNN).

8. The method of claim 1 wherein for each of the plurality of the future time steps, generating the predicted state of the real-world system for the future time step is performed using a trained fully connected neural network (FCNN)

9. The method of claim 1 wherein the predicted state of the real-world system for a future time-step includes a set of predicted observations and a prediction interval for each of the predicted observations.

10. The method of claim 1 wherein the set of data observations of the real-world system are measured using a respective set of observation sensing devices.

11. The method of claim 1 wherein each time series of the observed states from the real-world system is represented as a respective node in a graph and relationships between the respective times series are represented as graph edges that collectively define a graph topology, wherein:
for each of the plurality of the time steps in the time series of observed states, generating the hidden state for the time-step is also based on the graph topology; and
for each of the plurality of the future time including the first future time step in the future time series, generating the hidden state for the future time step is also based on graph topology.

12. The method of claim 1 wherein each predicted state of the real-world system includes, for each respective time-series, a posterior distribution of particles, wherein a mean of the posterior distribution is used as a predicted observation for the time-series for the future time step and the posterior distribution of particles is used to generate a confidence indicator.

13. A computing system comprising:
a processor;
a memory storing instructions which when executed by the processor causes the computing system to perform a method for probabilistic spatiotemporal forecasting comprising:
acquiring a time series of observed states from a real-world system, each observed state corresponding to a respective time-step in the time series and including a set of data observations of the real-world system for the respective time-step;
for each of a plurality of the time steps in the time series of observed states:
generating a hidden state for the time-step based on (i) the observed state for a prior time-step and (ii) an approximated posterior distribution generated for a hidden state for the prior time-step, and
generating an approximated posterior distribution for the hidden state generated for the time-step based on (i) the observed state for the time-step and (ii) the hidden state generated for the time-step;
generating a future time series of predicted states for the real-world system, each predicted state corresponding to a respective future time-step in the future time series, comprising:
for a first future time step in the future time series:
generating a hidden state for the first future time step based on (i) the observed state for a final time step in the time series of observed states; and (ii) the posterior distribution for the hidden state generated for the final time step in the time series of observed states, and
generating a predicted state of the real-world system for the first future time step based on the hidden state generated for the first future time step; and
for each of a plurality of the future time steps following the first future time step in the future time series:
generating a hidden state for the future time step based on (i) the predicted state of the real-world system generated for a prior future time step and (ii) the hidden state generated for a prior future time step, and
generating a predicted state of the real-world system for the future time step based on the hidden state generated for the future time step.

14. The system of claim 13 wherein the method comprises controlling the real-world system to modify future data observations of the real-world system based on the future time series of predicted states for the real-world system.

15. The system of claim 13 wherein the real-world system includes a road network and the set of data observations include traffic speed observations collected at a plurality of locations of the road network, the method comprising controlling a signaling device in the road network based on the future time series of predicted states for the real-world system.

16. The system of claim 13 wherein, for each of the plurality of the time steps in the time series of observed states, generating the approximated posterior distribution generated for the hidden state generated for the time-step comprises using a particle flow algorithm to migrate particles of the hidden state to represent the posterior distribution.

17. The system of claim 13 comprising a set of observation sensing devices, wherein the set of data observations of the real-world system are measured using the set of observation sensing devices.

18. The system of claim 13 wherein each time series of the observed states from the real-world system is represented as a respective node in a graph and relationships between the respective times series are represented as graph edges that collectively define a graph topology, wherein:
for each of the plurality of the time steps in the time series of observed states, generating the hidden state for the time-step is also based on the graph topology; and
for each of the plurality of the future time including the first future time step in the future time series, generating the hidden state for the future time step is also based on graph topology.

19. The system of claim 18 wherein each predicted state of the real-world system includes, for each respective time-series, a posterior distribution of particles, wherein a mean of the posterior distribution is used as a predicted observation for the time-series for the future time step and the posterior distribution of particles is used to generate a confidence indicator.

20. A computer-readable medium storing non-transient instructions for execution by a processing system that when executed cause the processing system to perform a method of:
acquiring a time series of observed states from a real-world system, each observed state corresponding to a respective time-step in the time series and including a set of data observations of the real-world system for the respective time-step;
for each of a plurality of the time steps in the time series of observed states:
generating a hidden state for the time-step based on (i) the observed state for a prior time-step and (ii) an approximated posterior distribution generated for a hidden state for the prior time-step, and
generating an approximated posterior distribution for the hidden state generated for the time-step based on (i) the observed state for the time-step and (ii) the hidden state generated for the time-step;
generating a future time series of predicted states for the real-world system, each predicted state corresponding to a respective future time-step in the future time series, comprising:
for a first future time step in the future time series:
generating a hidden state for the first future time step based on (i) the observed state for a final time step in the time series of observed states; and (ii) the posterior distribution for the hidden state generated for the final time step in the time series of observed states, and
generating a predicted state of the real-world system for the first future time step based on the hidden state generated for the first future time step; and
for each of a plurality of the future time steps following the first future time step in the future time series:
generating a hidden state for the future time step based on (i) the predicted state of the real-world system generated for a prior future time step and (ii) the hidden state generated for a prior future time step, and
generating a predicted state of the real-world system for the future time step based on the hidden state generated for the future time step.
